(19) United States
(12) Patent Application Publication
(10) Pub. No.: US 2007/0103308 A1
(43) Pub. Date: May 10, 2007

(54) Antenna structure for the radio frequency identification tag

(75) Inventor: Chien-Chih Chiu, Gueishan Township (TW)

Correspondence Address: EGBERT LAW OFFICES, 412 MAIN STREET, 7TH FLOOR, HOUSTON, TX, 77002, US

(73) Assignee: Wha Yu Industrial Co., Ltd., Hsinchu City (TW)

(21) Appl. No.: 11/262,013

(22) Filed: Oct. 31, 2005

(51) Int. Cl. G08B 13/14

(52) U.S. Cl. 340/572.7

(57) ABSTRACT

An antenna structure for the RFID Tag includes a carrier with an antenna attached to a surface thereof, the antenna being made of conductive material. The antenna is connected to an IC chip electronically. The antenna has a first and second radiating body connected to the IC chip separately. The first and second radiating body is connected to the IC chip and expanded in a coil until a proper length is reached. Thus, the first and second radiating body is spaced properly to construct a coiled antenna.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an antenna structure for the radio frequency identification tag (RFID Tag), and more particularly to an antenna with new structure and spatial arrangement.

### BACKGROUND OF THE INVENTION

The Radio Frequency Identification (RFID) Tag refers to a component comprised of an Integrated Circuit (IC) and antenna. Since the RFID Tag can read or write data from external sources with a RFID reader/writer, it can quickly identify the attributes of an object by wireless data transmission. Users can manage object movement and enhance logistical efficiency. Therefore, the RFID Tag is gradually replacing the conventional barcode and magnetic card.

The length of an antenna for an RFID Tag is determined by wavelength. While attempting to achieve optimal data transmission efficiency, the antenna length of the RFID Tag may result in an extra large size of the RFID Tag. In addition to high manufacturing costs, the size of the RFID Tag also leads to inconvenient usage.

Since the power supply for data reading and writing in a passive RFID Tag is achieved by the reader/writer, when the antenna of the RFID Tag receives the electric wave generated by the antenna of the reader/writer, the antenna forms resonate or radiation inside and generates an electronic wave to exchange the data between the reader/writer and the RFID Tag. When the antenna of the RFID Tag and reader/writer both use an antenna with linear polarization to receive and transmit the electromagnetic waves, and if the location of the product with the RFID Tag is uncertain or the relative angle causes cross polarization of the antennas for the reader/writer and RFID Tag, then the planes cannot be fixed to the same polarization. In other words, the antenna of the RFID Tag may use vertical, horizontal, or multi-angular cross polarization to read the electric wave from the antenna of the reader/writer, and when the polarization direction differs for the RFID Tag and reader/writer, the receiving distance for the RFID is significantly shortened. Moreover, it would disable the reader/writer from reading the RFID Tag data.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

1. The present invention arranges the first and second radiating body 21, 22 of the antenna 20 in coiled form on the carrier 10 to effectively solve the problem of extra length of the RFID Tag, having the antenna extending sideways so as to reduce size of the RFID Tag and the production cost.

2. The present invention uses the coiled shape of the first and second radiating body 21, 22 of the antenna to achieve circular polarization of the electric field for the antenna 20. In other words, the antenna 20 of the RFID Tag exchanges and reads the data of the electric wave with the reader/writer by rotating the electric wave circularly. Even if the antenna of the reader/writer is linear polarization type or the product installed with RFID Tag is placed at varied angles, it can still read data from the reader/writer remotely. Therefore, the present invention not only solves the problem of irregular reading by the conventional RFID Tag from the reader/writer or shorter distance being required for proper reading, but also enables the remote transmission of data for convenient commercial use.

The shape of the antenna 20 can optimize the performance, cost or other design factors, such as the embodiment of the antenna 20 shown in FIGS. 3, 4 and 5.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of a preferred embodiment of the present invention.

FIG. 2 shows a top plan view of FIG. 1.

FIG. 3 shows a perspective view of another preferred embodiment of the present invention.

FIG. 4 shows a top plan view of FIG. 3.

FIG. 5 shows a top plan view of another preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

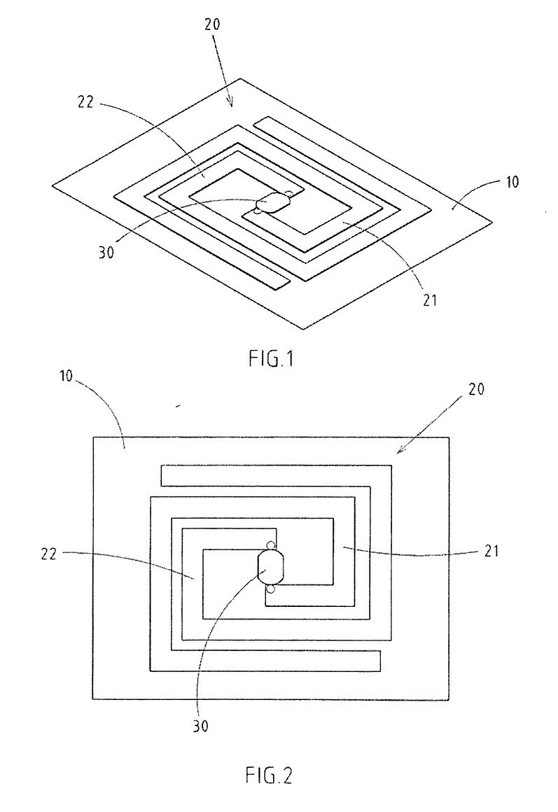

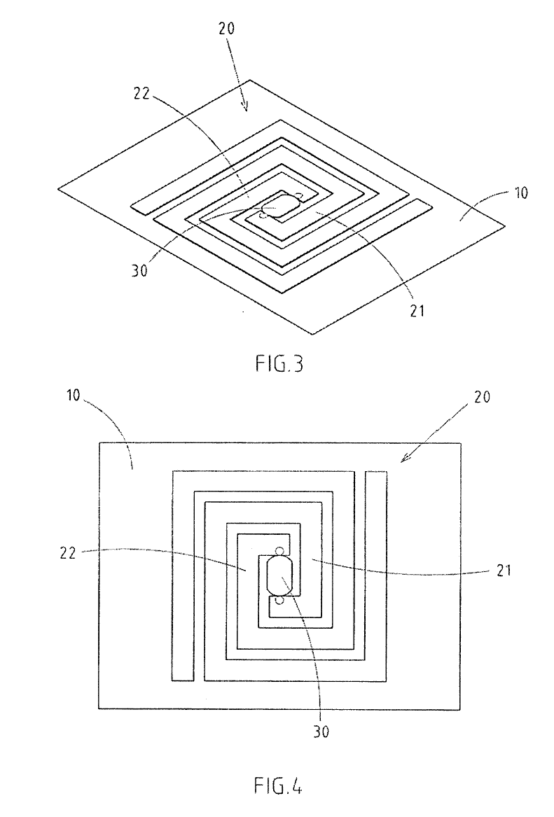

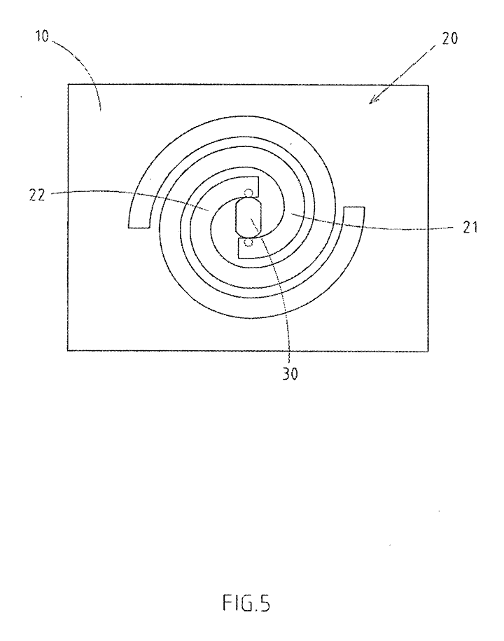

As shown in FIGS. 1-2, there is a preferred embodiment of the antenna structure for the RFID TAG.

The invention includes a carrier 10, having an antenna 20 attached to a surface thereof, the antenna 20 being made of conductive material. The antenna 20 is connected to an IC chip 30 electronically. The antenna 20 has a first and second radiating body 21, 22 of the antenna 20 being connected to the IC chip 30 separately. The first and second radiating body 21, 22 are connected to the IC chip and expanded in a coil until a proper length is reached, so that the first and second radiating body 21, 22 is spaced properly to construct a coiled antenna. Thus, the antenna can reduce the size of the RFID Tag and achieve the circular polarization of an electric field.

I claim:

1. An antenna structure for a RFID Tag, comprising:
a carrier; and
an antenna attached to a surface of the carrier, said antenna being comprised of conductive material and connected to an IC chip electronically;
wherein a first and second radiating body of the antenna is connected to the IC chip separately; and wherein the first and second radiating body are connected to the IC chip and expanded in a coiled shape until a proper length is reached, the first and second radiating body being spaced to construct a coiled antenna.
